(19) United States
(12) Patent Application Publication
(10) Pub. No.: US 2007/0183157 A1
(43) Pub. Date: Aug. 9, 2007

(54) Luminaire with a louver for controlling the light radiation

(75) Inventor: Petrus Adrianus Josephus Holten, Winterswijk (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,798

(22) PCT Filed: Mar. 3, 2005
(86) PCT No.: PCT/IB05/50796

§ 371 Date: Sep. 12, 2006

(30) Foreign Application Priority Data
Mar. 17, 2004 (EP) 04101103.2

(51) Int. Cl. F21V 11/02

(52) U.S. Cl. 362/291; 362/342

(57) ABSTRACT

A luminaire, comprising a light source (6,7) for producing light radiation leaving the luminaire through its front side. The luminaire comprises a dome-like concave reflector (1) around a central axis (2) perpendicular to said front side. The luminaire comprises a tubular louver (11), being positioned around said central axis (2) in front of the light source (6,7) and being located at least partly inside said concave reflector (1). The louver (11) has a substantial tubular wall and both sides (12,13) of the wall have a light reflecting surface. The louver (11) is connected with the remainder of the luminaire through connection means (17), which are substantially located in the area of the luminaire behind the louver (11). The connection means (17) engage the louver (11) near its back edge (15), which is directed to the light source (6,7).

The invention is related to a luminaire, comprising a light source for producing light radiation leaving the luminaire through its front side, whereby the luminaire comprises a concave reflector around a central axis perpendicular to said front side, whereby the dimensions of the cross section of the reflector perpendicular to said central axis decreases further away from the front side of the luminaire, whereby the luminaire comprises a tubular louver being positioned around said central axis in front of the light source and being located at least partly inside said concave reflector, whereby the louver has a substantial tubular wall with an inner side and an outer side, both sides having a light reflecting surface, whereby said louver is connected with the remainder of the luminaire through connection means.

Such luminaire is disclosed in DE-A-4006769, whereby the reflector has a circular cross section perpendicular to the central axis, and whereby the louver has a circular tubular wall being positioned coaxially to said central axis. A number of radial extending lamellae are present between the reflector and the louver. The lamellae as well as the louver have a substantially V-shaped cross section with the apex of the V-shape at the front edge of the louver and the lamellae respectively. Both sides of each lamella have a light reflecting surface. Thereby, the light radiation from the luminaire can leave the luminaire through the space surrounded by the louver and through a number of limited areas around the louver, whereby each area is bordered by a part of the louver, by a part of the reflector and by two neighbouring radial extending lamellae.

The louver and the radial extending lamellae are present for controlling the light radiation leaving the luminaire. In particular, when the luminaire is used for lightening an office space, whereby a number of luminaires are mounted in the ceiling, or mounted against the ceiling, or pending from the ceiling, it is important that there is an appropriate distribution of the light intensity within the downwardly directed light beam, whereby light radiation with relative small angles to the ceiling is avoided.

The known luminaires of the kind described above are provided with radial extending lamellae in the space between the louver and the surrounding reflector in order to connect the louver with the surrounding reflector. Thereby, the lamellae are used for additionally controlling the light radiation.

The object of the invention is a luminaire generating light radiation having an improved distribution of light intensity in the cross section of the light beam generated by the luminaire.

To accomplish with that object, said connection means—connecting the louver with the remainder of the luminaire—are substantially located in the area of the luminaire behind the louver, whereby said connection means engage the louver near its back edge, which is directed to the light source. The area of the luminaire behind the louver is the space inside the luminaire at back side of a flat plane through the back edge of the louver, i.e. at the side of that plane where the light source is present.

The reflector may have a rectangular or square cross section perpendicular to said central axis, and the louver may be rectangular or square tubular, but, preferably, the reflector has a substantial circular cross section perpendicular to said central axis, whereby the diameter of the cross section decreases further away from the front side of the luminaire, and whereby the louver has a circular tubular wall being positioned coaxially to said central axis.

So, there is only free space between the louver and the reflector. The light radiation leaves the luminaire through the round space within the louver and through the annular space between the louver and the surrounding reflector, without being influenced by any disturbing object in that annular space.

By experimentation and calculation it has been found that certain shapes of the lamellae may improve the distribution of the light intensity in the light beam. However, such improvement is achieved compared to other shapes of the lamellae, for example thin and flat lamellae. Surprisingly, it has been found that the best distribution of the light intensity within the light beam can be obtained by leaving out the radial extending lamellae.

The shape of the surrounding reflector may be conical, but preferably the main part of the reflector is concave in an axial section through the central axis. Thereby the shape of the reflector may be dome-like, and surrounding the interior space of the luminaire.

In one preferred embodiment, the tubular wall of the louver is substantially V-shaped in an axial section through the central axis, whereby the apex of the V-shape is at the front edge of the louver. Thereby, preferably the inner side and/or the outer side of the tubular wall of the louver are concave in an axial section through said central axis. Such shape of the louver, in combination with said concave shape of the reflector, generates an optimal light beam.

Preferably, the connection means comprise one or more brackets attached to the back edge of the louver. The other ends the brackets can be fixed to the surrounding reflector or the other parts of the luminaire.

In one preferred embodiment a substantial part of the connection means is transparent. The connection means may comprise a flat annular transparent member, whereby the outer edge of the member is connected with the reflector and the inner edge is connected to the back edge of the louver.

Preferably, the connection means comprise a transparent tubular connection member extending between the back edge of the louver and the concave reflector, whereby the tubular connection member is preferably provided with openings through which lamps can reach.

In one preferred embodiment, more coaxial annular louvers are present, whereby the louvers are connected to the remainder of the luminaire by connection means being substantially located in the area of the luminaire behind the louvers, and whereby said connection means engage the louvers near their back edges, which are directed to the light source.

In order to further elucidate the invention, an embodiment of a luminaire will be described, as well as two examples of a louver, referring to the drawing, in which:

FIG. 1 is a front view of a luminaire,

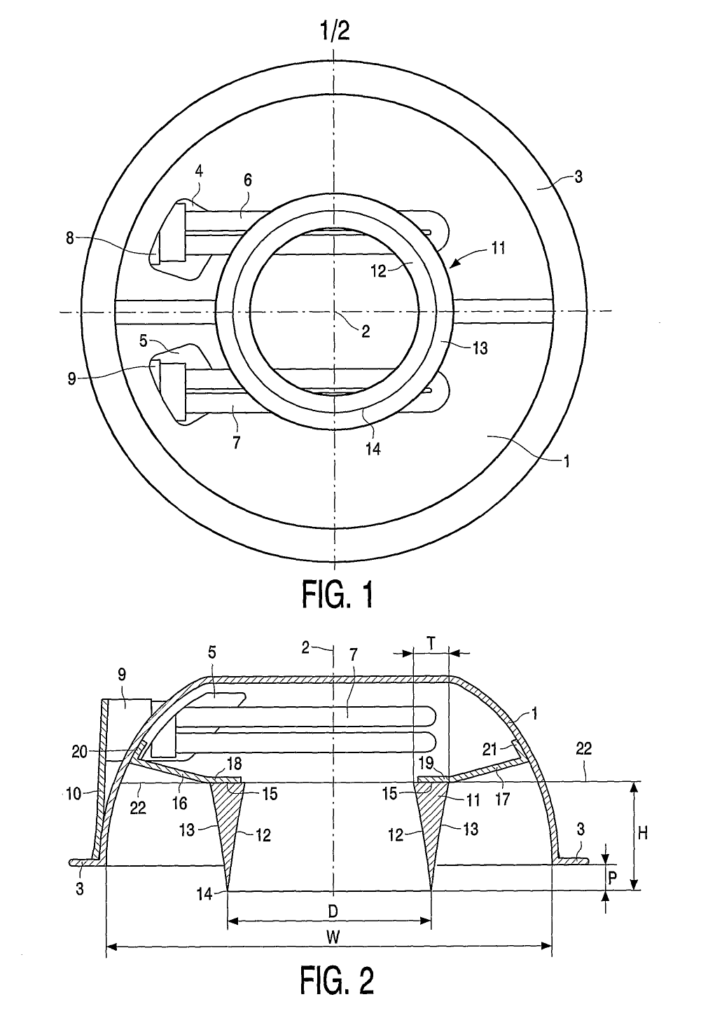

FIG. 2 is a sectional view according to the line II-II in FIG. 1,

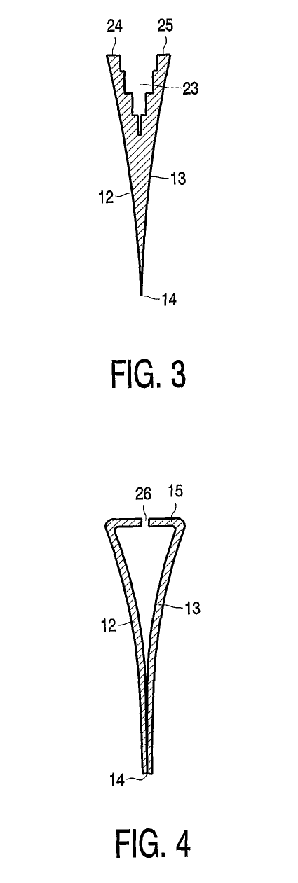

FIG. 3 is a sectional view of the wall of a first embodiment of a louver, and

FIG. 4 is a sectional view of the wall of a second embodiment of a louver.

The figures are diagrammatical representations of the luminaire. The luminaire shown in FIGS. 1 and 2 comprises a concave dome-like reflector 1 having a light reflecting surface at its inner side. The main part of the light reflecting surface of the dome-like reflector 1 is concave in an axial plane through the central axis 2, as represented in FIG. 2.

At the circular edge at the front side of the reflector 1 is an annular flange 3, said annular flange forming an outer border of the light emission window of the luminaire and said annular flange extending in a flat plane perpendicular to the central axis 2 of the luminaire. When the luminaire is mounted in a ceiling, for example, the flange 3 may cover the edge of the circular opening that is made in the ceiling to accommodate the luminaire.

The dome-like reflector 1 comprises two openings 4,5. Two lamps 6,7, for example gas discharge lamps, reach through the respective openings 4,5, so that the light generating parts of the lamps 6,7 are located inside the dome-like reflector 1. The fittings 8,9 of the lamps 6,7 are located outside the reflector 1, and are connected by means of a supporting member 10 to the back side of the reflector 1 near the flange 3.

Partly inside the dome-like reflector 1, and in front of the lamps 6,7, is a circular tubular louver 11, which is positioned coaxially to the central axis 2. The wall of the louver 11 is substantially V-shaped in an axial section through the central axis 2, as shown in FIG. 2. Thereby the legs of the V-shape are curved, so that the inner side 12 as well as the outer side 13 of the tubular wall of the louver 11 are concave in the axial section through the central axis 2, as shown in FIG. 2. The front edge 14 of the tubular louver 11 is a circle, and the back edge 15 comprises a flat annular surface perpendicular to the central axis 2.

The tubular louver 11 is connected to the dome-like reflector l by means of two brackets 16,17. One end 18,19 of each bracket 16,17 is attached to the back edge 15 of the louver 11, and the other ends 20,21 are attached to the inner side of the reflector 1. The parts can be connected by glue or by appropriate mechanical means like screws or bolds, or fit in an annual opening in the reflector 1. FIG. 2 shows that the brackets 16,17 are located in the area within the luminaire behind the louver 11. In FIG. 2 that area is located above the straight line 22 through the back edge 15 of the louver 11.

The different parts of the luminaire can be made of metal and/or plastic or other material. In the described example of a luminaire the reflector 1 and the brackets 16,17 are made of metal and the louver 11 is made of plastic material.

In FIG. 2, the diameter of the front side of the luminaire is indicated with W. The diameter of the front edge 14 of the louver 11 is indicated with D and the height of the louver 11 is indicated with H. The width of the back edge 15 of the louver 11 is indicated with T, and the distance that the louver 11 extends out of the front side of the reflector 1 is indicated with P.

In preferred embodiments:
0.35W<D<0.55W, preferably: 0.40W<D<0.50W, and/or
0.20W<H<0.30W, preferably: 0.23W<H<0.27W, and/or
0.04W<T<0.14W, preferably: 0.06W<T<0.12W, and/or
−0.15W<P<0.15W, preferably: −0.10W<P<0.10W.

As an alternative, the connection means for connecting the louver 11 with the reflector 1 may consist of a transparent tubular connection member extending between the back edge 15 of the louver 11 and the top part of the dome-like reflector 1, whereby the tubular connection member is provided with openings through which the lamps 6,7 can reach.

In the example of an embodiment of a luminaire as shown in FIGS. 1 and 2, the louver 11 is made of full plastic material and is massive, i.e. not hollow. FIGS. 3 and 4 show other examples of an embodiment of the louver 11, whereby the same reference numerals indicate similar parts as are indicated in FIGS. 1 and 2.

FIG. 3 is a sectional view of the wall of a tubular louver, whereby the louver is made of plastic material by means of an injection moulding process. In the sectional view, both sides 12,13 of the wall are curved, and both sides 12,13 are provided with a light reflecting surface. The tubular louver is more or less hollow, because the back edge of the louver is provided with a recess 23, so that the back edge is composed of two concentric annular surfaces 24,25, at both sides of the entrance of the recess 23. The front edge 14 of the louver is a more or less sharp edge.

FIG. 4 is a sectional view of a wall of a tubular louver, whereby the louver is made of metal sheet material. Therefore the louver is hollow, and the back edge 15 is provided with a small annular opening 26, where the edges of the sheet material meet. The louver can be made of one piece of sheet material or two parts of sheet material, whereby the two parts are welded or glued together at the front edge 14 of the louver.

The embodiments as described above are merely examples of a luminaire and a louver; a great many other embodiments are possible.

1. A luminaires comprising a light source (6,7) for producing light radiation leaving the luminaire through its front side, whereby the luminaire comprises a concave reflector (1) around a central axis (2) perpendicular to said front side, whereby the dimensions of the cross section of the reflector (1) perpendicular to said central axis (2) decreases further away from the front side of the luminaire, whereby the luminaire comprises a tubular louver (11) being positioned around said central axis (2) in front of the light source (6,7) and being located at least partly inside said concave reflector (1), whereby the louver (11) has a substantial tubular wall with an inner side (12) and an outer side (13), both sides (12,13) having a light reflecting surface, whereby said louver (11) is connected with the remainder of the luminaire through connection means (17), characterized in that said connection means (17) are substantially located in the area of the luminaire behind the louver (11), and in that said connection means (17) engage the louver (11) near its back edge (15), which is directed to the light source (6,7).

2. A luminaire as claimed in claim 1, characterized in that the reflector (1) has a substantial circular cross section perpendicular to said central axis (2), whereby the diameter of the cross section decreases further away from the front side of the luminaire, and in that the louver (11) has a circular tubular wall being positioned coaxially to said central axis (2).

3. A luminaire as claimed in claim 1, characterized in that the main part of the reflector (1) is concave in an axial section through said central axis (2).

4. A luminaire as claimed in claim 1, characterized in that the tubular wall of the louver (11) is substantially V-shaped in an axial section through said central axis (2), whereby the apex of the V-shape is at the front edge (14) of the louver (11).

5. A luminaire as claimed in claim 4, characterized in that said inner side (12) and/or said outer side (13) of the tubular wall of the louver (11) are concave in an axial section through said central axis (2).

6. A luminaire as claimed in claim 1, characterized in that said connection means comprise one or more brackets (17) attached to the back edge (15) of the louver (11).

7. A luminaire as claimed in claim 1, characterized in that a substantial part of said connection means (17) is transparent.

8. A luminaire as claimed in claim 7, characterized in that said connection means comprise a transparent tubular connection member extending between the back edge (15) of the louver (11) and the concave reflector (1), whereby the tubular connection member is preferably provided with openings through which lamps (6,7) can reach.

9. A luminaire as claimed in claim 1, characterized in that more coaxial annular louvers (11) are present, whereby the louvers (11) are connected to the remainder of the luminaire by connection means (17) being substantially located in the area of the luminaire behind the louvers (11), and whereby said connection means (17) engage the louvers (11) near their back edges (15), which are directed to the light source (6,7).
